(19) United States
(12) Patent Application Publication
(10) Pub. No.: US 2026/0105862 A1
(43) Pub. Date: Apr. 16, 2026

(54) METHODS AND SYSTEMS FOR LIVE CAPTION DISPLAY

(71) Applicant: Follow CC, Inc., Orient, NY (US)

(72) Inventors: Matthew Sonnenfeld, Orient, NY (US); Joshua Raymo, Portsmouth, RI (US)

(21) Appl. No.: 19/360,433

(22) Filed: Oct. 16, 2025

Related U.S. Application Data
(60) Provisional application No. 63/708,061, filed on Oct. 16, 2024.

(51) Int. Cl. G09B 21/00; G10L 15/26

(52) U.S. Cl. CPC G09B 21/009; G10L 15/26

(57) ABSTRACT

Disclosed are various embodiments for methods and systems of live caption display. Various embodiments can obtain a captioning file comprising a first caption and a second caption. Then, various embodiments can obtain a live transcript from a transcription service, the live transcript representing text generated from audio input. Various embodiments can then send a first instruction to a client device to display the first caption. Then various embodiments can calculate a first match percentage, the first match percentage representing a first amount that the first caption matches a first portion of the live transcription over a first word count of the first caption. Then, various embodiments can send a second instruction to the client device to display the second caption.

### CROSS-REFERENCE TO RELATED APPLICATIONS

This application claims priority to and the benefit of the filing date of U.S. Provisional Patent Application No. 63/708,061, filed October 16, 2024, the entirety of which is hereby incorporated by reference herein.

### BACKGROUND

Theaters and live performance venues are required by law to provide reasonable accommodations to individuals with disabilities. In the case of deaf or hard-of-hearing individuals, theaters and live performance venues may include the use of captions that coincide with the live performance. Traditionally, captions are advanced by a human operator who controls a computer system, advancing pre-written captions in pace with the speaker. Current captioning solutions suffer from several technical limitations that impact their effectiveness and accessibility. Manual caption synchronization systems depend on human operators to listen to the live performance and manually trigger the display of pre-written captions at appropriate times. This approach introduces human error, as operators may advance captions too early or too late, resulting in poor synchronization between the displayed text and the actual spoken content. The reliance on human operators also makes these systems expensive to deploy, particularly for venues with limited budgets or infrequent performances.

Existing automated transcription services, while capable of converting speech to text in real-time, present different technical challenges when applied to live performance environments. These systems generate transcriptions based on audio input processing, which can result in significant latency between spoken words and displayed text. The accuracy of real-time transcription systems can be compromised by factors, such as audio quality, speaker distance from microphones, background noise, and non-standard speech patterns common in theatrical performances, including singing, accented speech, or period-specific language. Additionally, transcription systems may struggle with proper nouns, character names, or specialized terminology frequently used in scripted performances.

The technical distinction between captioning and transcription services creates additional complexity for live performance venues. While transcription services convert audio input directly to text, captioning services display pre-written, text-accurate captions that correspond to the scripted content. Live performances benefit from captioning, rather than transcription, because the scripted nature of the content allows for preparation of accurate, properly formatted captions that include stage directions, speaker identification, and other contextual information that enhances the viewing experience for patrons with hearing disabilities.

Current captioning deployment systems also face scalability challenges. Many venues avoid implementing captioning services for short runs or single performances due to the setup complexity and operational costs associated with manual systems. This limitation reduces accessibility for patrons across the full calendar of performances, creating barriers to attendance for individuals who require captioning services.

### BRIEF DESCRIPTION OF THE DRAWINGS

The accompanying drawings, which are incorporated in and constitute a part of the present description serve to explain the principles of the apparatuses and systems described herein:

FIG. 1 shows an example system;

FIG. 2 shows an example flowchart of a method performed by a computing environment;

FIG. 3 shows an example caption processing system;

FIG. 4 shows a physical environment for implementing the caption processing system;

FIG. 5 shows an example client device; and

FIG. 6 shows an example flowchart of a method performed by a client device.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

Automated caption synchronization systems for live performances may address challenges associated with traditional manual captioning approaches. In some cases, conventional captioning methods rely on human operators to manually advance caption text during performances, which can result in timing inconsistencies and synchronization errors. The automated captioning system described herein may utilize speech recognition technology to generate real-time transcripts of live audio and automatically correlate the transcripts with pre-written caption content.

The system may employ speech-to-text processing to convert live audio input into digital text transcripts. In some cases, the generated transcripts may be processed through word matching algorithms that compare the live transcript content against pre-existing caption files. The word matching process may identify corresponding text segments between the live transcript and the stored captions, enabling the system to determine appropriate timing for caption display synchronization.

The automated approach may eliminate the need for manual caption advancement, while preserving text accuracy and maintaining synchronization with performer dialogue and audio content. In some cases, the system may provide real-time caption delivery to client devices, allowing audience members to access synchronized captions during live performances. The technical implementation may involve processing live audio streams, generating text transcripts, performing word matching operations, and coordinating caption display timing across multiple client devices.

The automated caption synchronization may accommodate variations in performance timing, speech patterns, and delivery styles that commonly occur during live performances. In some cases, the system may adapt to different speaking speeds and may handle deviations from scripted content while maintaining caption synchronization accuracy. The technical approach may provide a scalable solution for delivering synchronized captions to multiple audience members simultaneously during live theatrical, musical, or other performance events.

Various embodiments of the present disclosure are directed to methods and systems of live caption display. Theaters and live performance venues must comply with the various disabilities laws to provide reasonable accommodations to those with disabilities. In the case of deaf or hard-of-hearing individuals, theaters and live performance venues may include the use of captions that coincide with the live performance. Often providing captioning services can be incredibly technologically challenging to setup, taxing on the crew of the live performance, and cost prohibitive. Often, shows that perform only once or twice simply avoid providing captioning services because it is not cost effective. This limit availability and creates an undue burden on the patron.

However, by leveraging speech recognition and automatically matching a live transcript of what is being performed against the pre-written captions, embodiments of the present disclosure eliminate the need of the human operator while preserving both text-accuracy and sync with the speaker. Various embodiments of the present disclosure create a cost-effective solution that can be deployed at every performance, not just at specific performances, opening up the entire calendar of performances and events for patrons and audience members.

Captioning services and transcription services are different. Transcriptions take the current audio input, convert the audio to text, and display that text. Patrons often must wait on the computing environment to real-time process the audio to text, leading to latency issues. Further, transcriptions can often vary from device to device based on the location of the audio input, so one patron may receive a fairly accurate transcription, but another patron sitting further away may receive various inaccuracies. Further, various transcription services fail to appropriately identify non-English words, names, phrases, or other non-standard modalities of speaking (e.g., singing, etc.). Although live transcription may be valuable for non-scripted meetings and discussions, it is important that patrons receive the correct content when they view a scripted event. However, at times, performers in a live performance can go “off-script.” In those situations, a transcript can still be favorable because there is not an easily identifiable caption to follow the language in the transcript. Various embodiments of the present disclosure are directed to a system created to replace the need of manual intervention for the text-accurate captioning of live events.

As used in the specification and the appended claims, the singular forms “a,” “an,” and “the” include plural referents unless the context clearly dictates otherwise. Ranges can be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these cannot be explicitly described, each is specifically contemplated and described herein. This applies to all parts of this application including, but not limited to, steps in described methods. Thus, if there are a variety of additional steps that can be performed it is understood that each of these additional steps can be performed with any specific configuration or combination of configurations of the described methods.

As will be appreciated by one skilled in the art, the methods and systems can take the form of an entirely hardware embodiment, an entirely software embodiment, or an embodiment combining software and hardware aspects. Furthermore, the methods and systems can take the form of a computer program product on a computer-readable storage medium having computer-readable program instructions (e.g., computer software) embodied in the storage medium. More particularly, the present methods and systems can take the form of web-implemented computer software. Any suitable computer-readable storage medium can be utilized including hard disks, CD-ROMs, optical storage devices, magnetic storage devices, memristors, Non-Volatile Random Access Memory (NVRAM), Random Access Memory (RAM), flash memory, or a combination thereof.

Throughout this application reference is made to block diagrams and flowcharts. It will be understood that each block of the block diagrams and flowcharts, and combinations of blocks in the block diagrams and flowcharts, respectively, can be implemented by processor-executable instructions. These processor-executable instructions can be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions can also be stored in a computer-readable memory that can direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions can also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, can be implemented by special purpose hardware-based computer systems that perform the specified functions or steps, or combinations of special purpose hardware and computer instructions.

This detailed description can refer to a given entity performing some action. It should be understood that this language can in some cases mean that a system (e.g., a computer) owned and/or controlled by the given entity is actually performing the action.

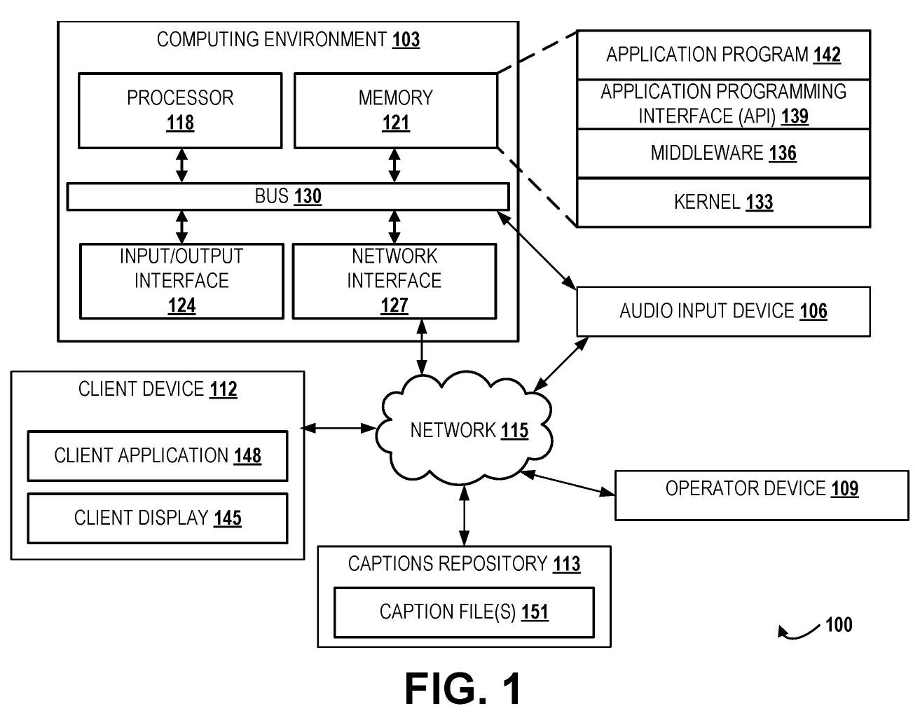

With reference to FIG. 1, shown is a network environment 100 according to various embodiments. The network environment 100 can include a computing environment 103, an audio input device 106, an operator device, a client device 112, and a captions repository 113, which can be in data communication with each other via a network 115.

The network 115 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI^{®}), BLUETOOTH^{®} networks, microwave transmission networks, as well as other networks relying on radio broadcasts. The network 115 can also include a combination of two or more networks 115. Examples of networks 115 can include the Internet, intranets, extranets, virtual private networks (VPNs), and similar networks.

The computing environment 103 can include one or more computing devices. For example, the computing devices can be configured to perform computations on behalf of other computing devices or applications. As another example, such computing devices can host and/or provide content to other computing devices in response to requests for content. In various embodiments, the computing environment can include the audio input device 106, a processor 118, a memory 121, an input/output (IO) interface 124, and/or a network interface 127, in data connection with each other over a bus 130 or over the network 115. Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

The bus 130 can include a circuit for connecting the bus 130, the processor 118, the memory 121, the network interface 127, and the input/output interface 124 to each other and for delivering communication (e.g., a control message and/or data) between the bus 130, the processor 118, the memory 121, the network interface 127, and the input/output interface 124.

The audio input device 106 can represent a device that is capable of capturing audio input of the live performance. The audio input device 106 can capture the audio input. In various embodiments, the audio input device 106 can convert the audio input from an analog wave formation to a digital audio file. In various embodiments, the digital file can be sent to a speech-to-text service (e.g., Microsoft® Cognitive Cervices Speech SDK, etc.) to be converted to a live transcript. In at least some embodiments, the audio input device 106 can include the speech-to-text service to convert the digital audio file to the live transcript. In at least other embodiments, the audio input device 106 can send the digital audio file over the network 115 to the computing environment, which at least one of the middleware 136 or the API 139 of the computing environment 103 can convert the digital audio file into the live transcript. In yet another embodiment, the audio input device 106 can be connected directly to the computing environment 103, therefore the digital audio file can be sent over the bus 130 to at least one of the middleware 136 or the API 139 to convert the digital audio file into a live transcript. The audio input device 106 can include various microphones, audio interfaces, voice recorders, instrument pickups, and various other types of devices.

The processor 118 can include one or more of a Central Processing Unit (CPU), an Application Processor (AP), and a Communication Processor (CP). The processor 118 can control, for example, at least one of the bus 130, the memory 121, the network interface 127, and the input/output interface 124 of the computing environment 103 and/or can execute an arithmetic operation or data processing for communication. The processing (or controlling) operation of the processor 118 according to various embodiments is described in detail with reference to the following drawings.

The processor-executable instructions executed by the processor 118 can be stored and/or maintained by the memory 121. The memory 121 can include a volatile and/or non-volatile memory. The memory 121 can comprise random-access memory (RAM), flash memory, solid state or inertial disks, or any combination thereof. The memory 121 can store, for example, a command or data related to at least one of the bus 130, the processor 118, the memory 121, the network interface 127, and the input/output interface 124 of the computing environment 103. As an example, the memory 121 can store a software and/or a program. The program can include, for example, a kernel 133, a middleware 136, an Application Programming Interface (API) 139, and/or an application program (or an “application”) 142, or the like, configured for controlling one or more functions of the server computing device 101 and/or an external device. At least one part of the kernel 133, middleware 136, or API 139 can be referred to as an Operating System (OS). The memory 121 can include a computer-readable recording medium having a program recorded therein to perform the method according to various embodiment by the processor 118.

The kernel 133 can control or manage, for example, system resources (e.g., the bus 130, the processor 118, the memory 121, etc.) used to execute an operation or function implemented in other programs (e.g., the middleware 136, the API 139, or the application program 142). Further, the kernel 133 can provide an interface capable of controlling or managing the system resources by accessing individual constitutional elements of the computing environment 103 in the middleware 136, the API 139, and/or the application program 142.

The middleware 136 can perform, for example, a mediation role so that the API 139 or the application program 142 can communicate with the kernel 133 to exchange data. Further, the middleware 136 can handle one or more task requests received from the application program 142 according to a priority. For example, the middleware 136 can assign a priority of using the system resources (e.g., the bus 130, the processor 118, or the memory 121) of the computing environment 103 to at least one of the application programs 142. For example, the middleware 136 can process the one or more task requests according to the priority assigned to the at least one of the application programs, and thus can perform scheduling or load balancing on the one or more task requests.

The Application Programming Interface (API) 139 can include at least one interface or function (e.g., instruction), for example, for file control, window control, video processing, or character control, as an interface capable of controlling a function provided by the application program 142 in the kernel 133 or the middleware 136.

The application program 142 can include logic (e.g., hardware, software, firmware, etc.) that can be implemented to perform various functionality. For instance, the application program 142 can obtain a captioning file 151 from a captions repository 113. The application program 142 can generate a unique identifier for the live performance associated with the captioning file 151. The application program 142 can also obtain a live transcript of the live performance from an audio input device 106. The application program 142 can send an instruction to a client device 112 to display a caption. The application program 142 can then determine, based on various word matching calculations, whether to proceed to another caption (e.g., the next caption, return to a previous caption, skip ahead to a later caption, etc.). Alternatively, the application program 142 can receive input from an operator indicating to manually proceed to another caption. The application program 142 can then direct the client devices 112 to display another caption. The process can repeat until the entirety of the captions file 151 is completed.

The input/output interface 124 can include an interface for delivering an instruction or data input from a user (e.g., an operator of the computing environment 103) or from a different external device (e.g., client device 112 or other computing devices) to the different elements of the computing environment 103. The input/output interface 124 can further include an interface for outputting one or more user interfaces to the user. For example, the input/output interface 124 can comprise a display, such as a touch screen display, and/or one or more physical input interfaces (e.g., keyboard, mouse, etc.) configured to receive user inputs. Further, the input/output interface 124 can output an instruction or data received from one or more elements of the computing environment 103 to one or more external devices (e.g., client device 112 or other computing devices).

The network interface 127 can establish, for example, communication between the computing environment 103 and one or more external devices (e.g., client device 112 or other computing devices). For example, the network interface 127 can communicate with the one or more external devices (e.g., the client device 112 or other computing devices) by being connected to the network 115 through wireless communication or wired communication. The network interface 127 can be configured to communicate with the one or more external devices (e.g., the client device 112 or other computing devices) via the network 115 (e.g., Internet, LAN, etc.). In an example, the network interface 127 can be configured to access the network 115 via a wireless communication interface such as a cellular communication protocol. The cellular communication protocol can comprise at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the wireless communication interface can be configured to use a near-distance communication. The near-distance communication interface can include for example, at least one of Wireless Fidelity (WiFi), Bluetooth, Bluetooth Low Energy (BLE), Near Field Communication (NFC), Global Navigation Satellite System (GNSS), and the like. According to a usage region or a bandwidth or the like, the GNSS can include, for example, at least one of Global Positioning System (GPS), Global Navigation Satellite System (GLONASS), BeiDou Navigation Satellite System (BDS), Galileo, the European global satellite-based navigation system, and the like. Hereinafter, “GPS” and “GNSS” can be used interchangeably in the present document.

The computing environment 103 can include one or more databases. In one example, the one or more databases can comprise one or more relational databases that use structured query language (SQL) for storing and processing data. In another example, the one or more databases can comprise one or more non-relational databases that use non-structured query language (NoSQL) for storing and processing data.

The operator device 109 can represent a computing device that can be used to manually override the caption display for the client devices 112. For instance, the operator device 109 can obtain input indicating that the client devices 112 are currently out of sync and the current caption being displayed on the client device 112 needs to transition to another caption. The operator device 109 can send a notification to the application program 142 of the computing environment to direct the application program 142 to proceed to another caption. Subsequently, the application program 142 of the computing environment 103 can send a notification to the client device 112 to proceed to another caption of the plurality of captions.

The client device 112 can represent a device that be used to display captions to a patron, client, or visitor. In various embodiments, the client device 112 can represent a device brought to a live performance by a patron, client, or visitor of the theater or live performance. The client device 112 can be a smartphone, a tablet, a laptop, or other specialty captioning devices. The client device 112 can include a client display 145, such as a display screen, an LED/LCD/OLED screen, a braille output reader device. In various embodiments, the client device 112 can include various features that allow the patron, client, or visitor to interact with the client display 145 (e.g., a touch screen display, etc.) such that the client can interact with a user interface of the client application 148. The client device 112 can include a client application 148 that can be stored in the client memory and executed by a client processor. The client application 148 can represent a built-in application, a browser application, or a standalone application that can be used to display captions to the patron, client or visitor. In various embodiments, the client can be prompted (via the user interface shown on the client display 145) to identify which performance they wish to have captions for. The client can open a link sent by the computing environment 103, or follow a link stored in a quick response (“QR”) code that is captured by the client device 112, to subscribe to the particular live event. Once the live event begins, the captions will begin displaying on the client display 145.

The client application 148 operates to facilitate the display of captions during a scripted live event by first enabling a user to access the event through either scanning a QR code with an optical device or receiving a unique link provided by the computing environment 103. Once the link is followed, the client application 148 requests and receives confirmation that captions will be delivered to the client device 112. The client application 148 then receives a plurality of captions, which may include an entire caption file 151, and subsequently processes instructions to display individual captions. Depending on the implementation, the client application 148 may directly receive caption text or an identifier indicating which caption from the file should be displayed. Captions are then presented on the client display 145, which can be configured to show multiple captions simultaneously or in a fixed-sized queue where new captions push earlier ones aside while still keeping them visible for a time. For example, the client display 145 may show three captions at once, with older captions gradually being removed as new ones arrive. After displaying a caption, the client application 148 sends a confirmation back to the computing environment 103 that the caption is being shown, and the process repeats until all captions for the live event have been displayed.

The captions repository 113 can represent computing device or database comprising one or more caption files 151. The captions repository 113 can represent the organization which licenses out the scripted live performances for which the caption files 151 are associated. In some embodiments, the captions 113 can represent database of scripted live performances. The application program 142 can obtain the caption file 151 from the captions repository 113 so that the live performance corresponding to the captions file 151 can be viewed by persons with a hearing disability. The captions file 151 can be a file that includes the text the scripted live performance. In various embodiments, the captions file 151 can be formatted to indicate the voice of one or more speakers to indicate which caption follows which speaker. In some embodiments, the captions have a specified sequence. In some embodiments, the captions can include scene descriptions, actor tone/emotion information, and other non-dialog information that may be valuable to a person unable to hear the performance.

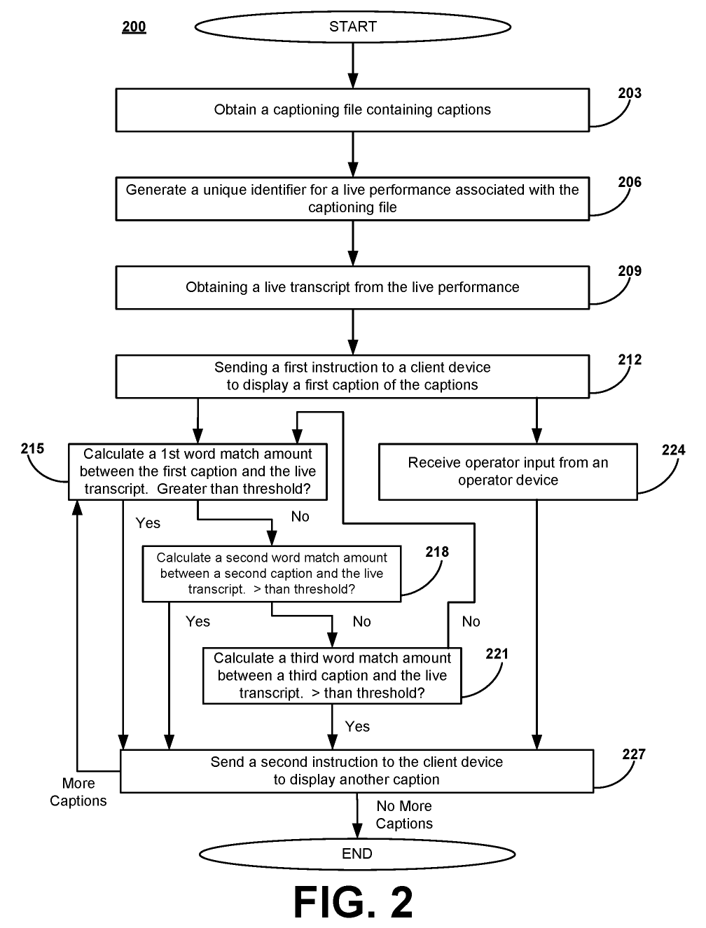

Referring next to FIG. 2, shown is a flowchart depicting a method 200 that provides one example of the operator of a portion of the application program 142 according to various embodiments of the present disclosure. The flowchart of FIG. 2 provides merely an example of the many different types of functional arrangements that can be employed to implement the operation of the depicted portion of the application program 142. As an alternative, the flowchart of FIG. 2 can be viewed as depicting an example of elements of a method implemented within the network environment 100.

Beginning with block 203, the program application 142 can obtain a captions file 151. In various embodiments, the program application 142 can obtain the captions file 151 from a captions repository 113 for a specified scripted live event. In at least some embodiments, the program application 142 can send a request to obtain the captions file 151 for the scripted live event and the captions repository 113 can process that request and return the corresponding caption file 151. In various embodiments, captions file 151 can include a plurality of captions. Various embodiments of the present disclosure can describe the plurality of captions using specific individual captions, such as a first caption, a second caption, and a third caption, ongoing to an Nth caption. The designation of first caption, second caption, and third caption (and ongoing) do not indicate order of the captions unless explicitly denoted. For example, there are various embodiments where a first caption is a caption other than the first in the caption file. Further, in various embodiments, a second caption or a third caption might be before a first caption sequentially.

Next, at block 206, the program application 142 can generate a unique identifier for the live performance. In various embodiments, the unique identifier can uniquely identify a run of performances of a specified show from other performances. For instance, a theater can have a run of performances of the play, “Hamlet.” A unique identifier can be generated for the entirety of the run of performances of the play, “Hamlet,” such that the theater organizers would only need to generate a single unique identifier that would be available for all three performances. Such an embodiment would encourage theaters to purchase bulk purchases of marketing material (e.g., playbills, showbill, programs, etc.) that can include the unique identifier shown as a quick response (“QR”) code or a unique link (i.e., uniform resource locator “URL”). In various embodiments, the unique identifier can uniquely identify the specific live performance from other live performances. For example, a live performance that performs over three nights sequentially would have three unique identifiers, one for each night. As such, the live performance organizers can provide the unique identifier to the patrons (clients) such that only the current patrons can view/consume the captions being sent to their respective client devices while prior patrons will not continue to receive access to the captions. In various embodiments, the program application 142 can generate the unique identifier as a quick response (“QR”) code, which can be displayed for patrons to scan on their respective client devices 112. In various embodiments, the program application 142 can generate the unique identifier as a portion of a uniform resource locator (“URL”), also referred to as a unique link to the captions. In such embodiments, the URL can be sent to the client device 112 such that the client device 112 can follow the URL. When a client device 112 scans the QR code or follows the URL associated with the unique identifier, the client device 112 is then subscribed to receive the captions, which can be displayed as directed by the application program 142.

Continuing to block 209, the program application 142 can obtain a live transcript. In various embodiments, the program application 142 can obtain the live transcript from a transcription service of the audio input device 106. In various embodiments, the computing environment 103 can receive an audio file from the audio input device 106, which can be processed by at least one of the middleware 136 or the API 139, which can be converted from audio to text and provided to the application program 142. In various embodiments, the transcription service is a speech-to-text (S2T) service configured to receive the audio input from an audio input device 106 and can convert the audio input into text. In various embodiments, the computing environment 103 or the audio input device 106 can continuously and/or repeatedly convert or transcribe the audio input into the live transcript.

Next, at block 212, the program application 142 can send a first caption of the plurality of captions for the caption file 151 to the client devices 112. In at least some embodiments, the program application 142 can send the entirety of the plurality of captions to the client device 112. In such an embodiment, the program application 142 can send an instruction to the client devices 112 to display a specified caption (e.g., a first caption). As a result, a client device 112 can display the specified caption (e.g., a first caption). Subsequent to block 212, the process can continue to block 215 and/or block 224.

Continuing from block 212 to block 215, the program application 142 can calculate a first word match amount between the first caption and the live transcript. For example, a first caption can state: “But soft, what light through yonder window breaks?” A live transcription can be processing the spoken language of the live scripted performance in real time. The live transcription might read: “He jests at scars that never felt a wound. But soft, what”, which represents the previous caption and a portion of the current caption (the first caption). The program application 142 can calculate the number of words within the live transcription that match the first caption. In this example, only three words match sequentially (“But soft, what”). The entirety of the first caption (“But soft, what light through yonder window breaks?”) is eight words long. Therefore, the program application 142 can identify that the live transcription is three eighths through the first caption. Three eighths as a percentage is thirty-seven and one-half percent. If that percentage (or match amount) equals or exceeds a first predetermined threshold then the program application 142 can proceed to block 227. If the percentage (or match amount) is less than (or equal to in some embodiments) the predetermined threshold, then the program application 142 can proceed to block 218. In various embodiments, the calculation can be performed in response to identifying a change in the live transcript.

Next, at block 218, the program application 142 can calculate a second word match amount between a second caption and the live transcript. In at least some embodiments, the program application 142 can calculate the second word match amount in response to determining that the first match percentage fails to exceed a first predetermined threshold. In at least some embodiments, the second word match amount can be a percentage. In at least some embodiments, the second match percentage can represent a second amount that at least a second portion of the second caption matches the first portion of the live transcription over a second word count of the second portion of the second caption.

As an example, the currently displayed caption (the first caption) is “But soft, what light through yonder window breaks?” and the next upcoming caption (the second caption) is “It is the East, and Juliet is the sun.” In the event that the live transcript did not have enough words to match the first caption (at block 215), then the live transcript can be compared to the second caption. For instance, the live transcript can be “window breaks. It is the east and Juliet is the”. In this example, only two of the words (“window breaks”) match the first caption (“But soft, what light through yonder window breaks?”), so the transcript may not meet the first predetermined threshold. Accordingly, the program application 142 can determine the amount of match between the second caption (“It is the East, and Juliet is the sun”) and the live transcript (“window breaks. It is the east and Juliet is the”). In this case, eight out of nine words of the live transcript match the second caption. If that percentage (or match amount) equals or exceeds a second predetermined threshold then the program application 142 can proceed to block 227. If the percentage (or match amount) is less than (or equal to in some embodiments) the second predetermined threshold, then the program application 142 can proceed to block 221.

Continuing to block 221, the program application 142 can calculate a third word match amount between a third caption and the live transcript. In at least some embodiments, the program application 142 can calculate the third word match amount in response to determining that the first match percentage fails to exceed a first predetermined threshold and the second match percentage fails to exceed a second predetermined threshold. In at least some embodiments, the third word match amount can be a percentage. In at least some embodiments, the third match percentage can represent a third amount that at least a third portion of the third caption matches the live transcription over a third word count of the third portion of the third caption.

As an example, the currently displayed caption (the first caption) is “But soft, what light through yonder window breaks?” and the next upcoming caption (the second caption) is “It is the East, and Juliet is the sun.” The program application 142 can search for another caption earlier or later in the caption file 151. For example, a third caption can be “Arise, fair sun, and kill the envious moon.” In the event that the live transcript did not have enough words to match the first caption (at block 215) and the live transcript did not have enough words to match the second caption (at block 218), then the live transcript can be compared to the third caption. If a percentage (or match amount) of the live transcript equals or exceeds a third predetermined threshold then the program application 142 can proceed to block 227. If the percentage (or match amount) of the live transcript is less than (or equal to in some embodiments) the third predetermined threshold, then the process can continue with block 221 until a matching caption is found, which then the process can continue to block 227. In some embodiments, instead of identifying the third caption, the program application 142 can take a portion of the live transcript as a third caption. In such embodiments, the performers might have gone “off-script,” where their speech and behaviors do not match a portion of the script. Alternatively, some live performances (e.g., concerts, etc.) intentionally include portions where impromptu, unscripted speech is provided to the live audiences. In such embodiments, the program application 142 can select the live transcript as the third caption before the process continues to block 227.

Returning back to block 212, the process can continue to block 224, where the program application 142 can receive operator input from an opera tor device 109. In various embodiments, the program application 142 can receive the operator input that indicates that the client devices 112 should display a different caption (e.g., a second caption, a third caption, etc.). In various embodiments, the application program 142 can verify that the caption exists within the caption file 151 and proceed to block 227.

From one of block 215, block 218, block 221, or block 224, the process can proceed to block 227. At block 227, the program application 142 can send a second instruction to the client device 112 to display another caption (e.g., a second caption, a third caption, etc.). In at least some embodiments, the program application 142 may have sent the entirety of the plurality of captions to the client device 112. In such an embodiment, the program application 142 can send an instruction to the client devices 112 to display a specified caption (e.g., a second caption, a third caption, etc.). As a result, a client device 112 can display the specified caption (e.g., a second caption, a third caption, etc.). Subsequent to block 227, the process can return to block 215 in the event that there are additional captions that have not yet been displayed. Alternatively, subsequent to block 227, the process can come to an end.

The method 200 described in FIG. 2 represents a technical improvement over conventional captioning systems by addressing computational challenges associated with real-time synchronization in live performance environments. Traditional captioning approaches suffer from human operator dependency, which introduces timing inconsistencies and synchronization errors due to reaction time delays and processing limitations. The automated word matching methodology implemented through blocks 215, 218, and 221 may eliminate these technical limitations by performing real-time computational analysis of live transcript data against stored caption content using predetermined threshold calculations. The system may reduce processing overhead by utilizing algorithmic matching operations rather than continuous monitoring, enabling more efficient resource allocation across multiple client devices simultaneously. In some aspects, the multi-level caption matching approach may provide improved accuracy in caption timing by removing human reaction time variables and processing delays associated with conventional caption advancement systems, while accommodating performance variations through automated fallback mechanisms when initial word matching operations fail to exceed predetermined thresholds.

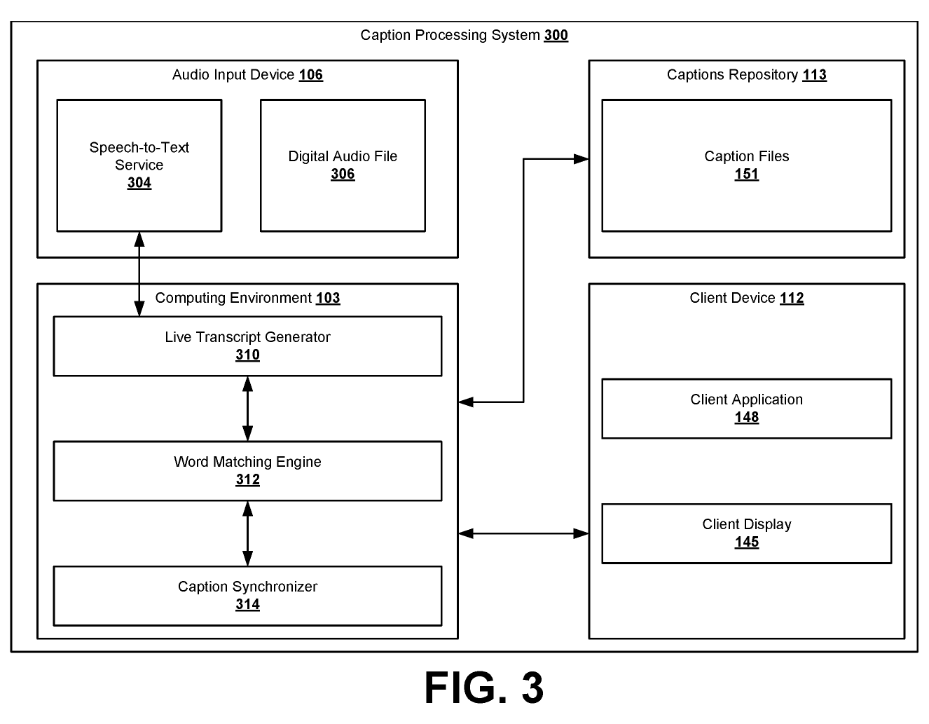

Referring to FIG. 3, a Caption Processing System 300 may provide automated caption synchronization for live performances through coordinated interaction between multiple system components. The Caption Processing System 300 may include an Audio Input Device 106, a Computing Environment 103, a Client Device 112, and a Captions Repository 113. In some cases, the Audio Input Device 106 may comprise an audio input device 106 that contains a Speech-to-Text Service 304 and a Digital Audio File 306. The Audio Input Device 106 may be configured to capture audio input of a live performance and convert the captured audio into digital format for processing.

The audio input device 106 may receive audio input from the live performance and convert the audio input to a digital audio file 306. In some cases, the Speech-to-Text Service 304 may process the Digital Audio File 306 to generate live transcripts of the performance audio. The speech-to-text processing may convert spoken dialogue and audio content into text format, enabling the system to analyze performance content in real-time. The Audio Input Device 106 may transmit the generated live transcript data to other system components for further processing and analysis.

With continued reference to FIG. 3, the Computing Environment 103 may comprise a processor and memory and may contain a Live Transcript Generator 310, a Word Matching Engine 312, and a Caption Synchronizer 314. The Live Transcript Generator 310 may obtain live transcripts of the live performance from the Audio Input Device 106 and may process the transcript data for comparison operations. In some cases, the Word Matching Engine 312 may calculate word match amounts between captions and the live transcript by determining a number of words in the live transcript that match words in a caption and calculating a percentage based on the number of matching words over a total word count of the caption.

The Word Matching Engine 312 may determine whether calculated word match amounts exceed predetermined thresholds to trigger caption advancement. In some cases, the Word Matching Engine 312 may determine a number of words in the live transcript that sequentially match words in a caption and may calculate a percentage based on the number of sequentially matching words over the total word count. The Caption Synchronizer 314 may send instructions to client devices to display captions when word match amounts exceed the predetermined thresholds. The Caption Synchronizer 314 may coordinate caption display timing across multiple client devices simultaneously during live performances.

As further shown in FIG. 3, the Client Device 112 may comprise a display and may include a Client Application 148 with a client application module 148 and a Client Display 145 with a client display module 145. The client application module 148 may receive caption content and display instructions from the Caption Synchronizer 314. In some cases, the client display module 145 may present synchronized captions to audience members through the Client Display 145. The Client Device 112 may receive a first caption of a plurality of captions and may subsequently receive instructions to display a second caption when word match amounts exceed predetermined thresholds.

The Captions Repository 113 may store Caption Files 151 through a caption files module 151 and may be configured to store caption files for multiple scripted live events. In some cases, the caption files may comprise a plurality of captions for scripted live events. The system may obtain captions files from the Captions Repository 113 and may generate unique identifiers for live performances to associate caption content with specific performance instances. The Caption Files 151 may contain pre-written caption text that corresponds to scripted dialogue and performance content.

The Caption Processing System 300 may perform automated caption synchronization operations through coordinated component interactions. The system may obtain a captions file comprising a plurality of captions for a scripted live event from the Captions Repository 113 and may generate a unique identifier for the live performance. In some cases, the system may obtain a live transcript of the live performance from the Audio Input Device 106 and may send a first caption of the plurality of captions to the Client Device 112. The Word Matching Engine 312 may calculate a first word match amount between the first caption and the live transcript and may determine whether the first word match amount exceeds a first predetermined threshold. The Caption Synchronizer 314 may send an instruction to the Client Device 112 to display a second caption when the first word match amount exceeds the first predetermined threshold.

The system may accommodate manual override capabilities through operator input from an operator device. In some cases, the system may receive operator input from an operator device indicating to display a different caption and may send an instruction to the client device to display the different caption in response to the operator input. The operator device may be configured to provide operator input to manually override caption display when performance variations or timing adjustments occur during live events.

The Caption Processing System 300 architecture may represent a technological improvement over conventional manual caption systems by eliminating human operator dependency for caption advancement timing. In some cases, the automated approach may reduce synchronization errors that commonly occur with manual caption operation and may enable cost-effective deployment for all performances regardless of budget constraints. The system may provide scalable caption delivery to multiple client devices simultaneously while maintaining synchronization accuracy across different performance venues and event types.

The Caption Processing System 300 provides a technical solution to the computational challenges of real-time caption synchronization in live performance environments. In some cases, traditional captioning systems suffer from latency issues and synchronization errors due to manual operator intervention, which creates timing inconsistencies between audio content and displayed text. The automated word matching approach implemented by the Word Matching Engine 312 eliminates these technical limitations by performing real-time computational analysis of live transcript data against stored caption content. The system reduces processing overhead by utilizing predetermined threshold calculations rather than continuous manual monitoring, enabling more efficient resource allocation across multiple client devices simultaneously. In some aspects, the automated synchronization provides improved accuracy in caption timing by removing human reaction time variables and processing delays associated with conventional caption advancement systems.

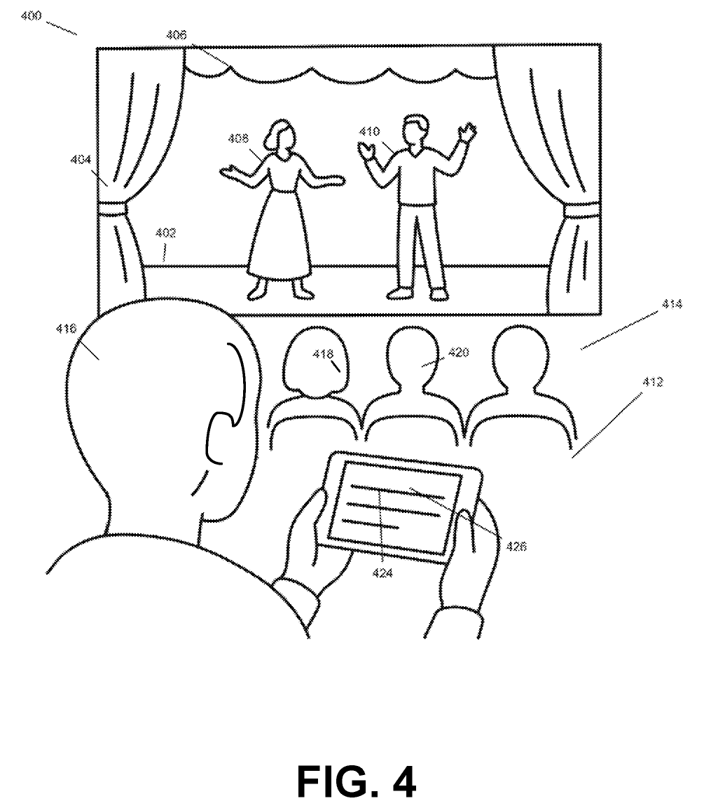

Referring to FIG. 4, a performance venue 400 may provide a physical environment for implementing the Caption Processing System 300 during live theatrical performances. The performance venue 400 may include a stage 402 with curtains 404 and a valance 406 that frame the performance area. In some cases, the venue architecture may incorporate structural elements including a speaker opening that can accommodate audio equipment and technical infrastructure for the automated caption synchronization system. The stage 402 may serve as the primary performance area where live audio content is generated and captured for transcript processing.

A first performer 408 and a second performer 410 may present the live performance on the stage 402, generating spoken dialogue and audio content that serves as input for the Caption Processing System 300. In some cases, the Audio Input Device 106 may capture audio from the first performer 408 and the second performer 410 through microphones or audio recording equipment positioned within the performance venue 400. The Speech-to-Text Service 304 may process the captured audio to generate live transcripts of the dialogue and performance content delivered by the first performer 408 and the second performer 410.

The performance venue 400 may include a seating area 412 that contains an audience 414 comprising multiple audience members positioned throughout the venue. In some cases, the audience 414 may include a first audience member 416, a second audience member 418, and a third audience member 420 who may access synchronized captions during the live performance. A viewer (such as first audience member 416) may utilize a tablet device 424 displaying a caption display 426 to view synchronized captions generated by the Caption Processing System 300. The tablet device 424 may represent one implementation of the Client Device 112, and the caption display 426 may correspond to the Client Display 145 described in the system architecture.

The Caption Processing System 300 may accommodate performance variations and off-script moments through multi-level caption matching operations when initial word match calculations fail to exceed predetermined thresholds. In some cases, the Word Matching Engine 312 may calculate a second word match amount between a second caption and the live transcript when the first word match amount fails to exceed the first predetermined threshold. The system may determine whether the second word match amount exceeds a second predetermined threshold and may send an instruction to the client device to display the second caption when the second word match amount exceeds the second predetermined threshold.

With continued reference to FIG. 4, the Caption Processing System 300 may perform additional caption matching operations to handle extended performance deviations or improvised content. The Word Matching Engine 312 may calculate a third word match amount between a third caption and the live transcript when the second word match amount fails to exceed the second predetermined threshold. In some cases, the system may determine whether the third word match amount exceeds a third predetermined threshold and may send an instruction to the client device to display the third caption when the third word match amount exceeds the third predetermined threshold. The multi-level matching approach may enable the system to maintain caption synchronization accuracy even when performers deviate from scripted dialogue or timing.

The unique identifier for accessing the Caption Processing System 300 may be implemented through various digital formats to facilitate patron access throughout the performance venue 400. In some cases, the unique identifier may comprise a quick response (QR) code that audience members can scan using mobile devices to connect to the caption service. The unique identifier may alternatively comprise a uniform resource locator (URL) that patrons can enter into web browsers or applications to access synchronized captions. The QR code or URL implementation may enable audience members positioned throughout the seating area 412 to easily connect their devices to the Caption Processing System 300 regardless of their physical location within the performance venue 400.

As further shown in FIG. 4, the interactions between the first performer 408 and the second performer 410 may generate audio content that flows through the complete caption processing workflow. The Live Transcript Generator 310 may process audio input from the performers to create real-time transcripts, while the Word Matching Engine 312 may compare the transcript content against stored caption files to determine appropriate display timing. The Caption Synchronizer 314 may coordinate caption delivery to multiple client devices simultaneously, enabling the viewer 422 and other audience members throughout the seating area 412 to receive synchronized captions on their respective devices during the live performance.

The performance venue 400 implementation may represent a technological improvement over conventional caption systems by enabling scalable deployment across all performances regardless of venue size or budget constraints. In some cases, the automated approach may provide accessibility for patrons throughout the venue regardless of seating location, eliminating the need for dedicated caption display screens or specialized seating areas. The system may accommodate off-script moments through multi-level caption matching operations that maintain synchronization accuracy even when performers deviate from scripted content, providing a robust solution for live performance captioning that adapts to the dynamic nature of theatrical presentations.

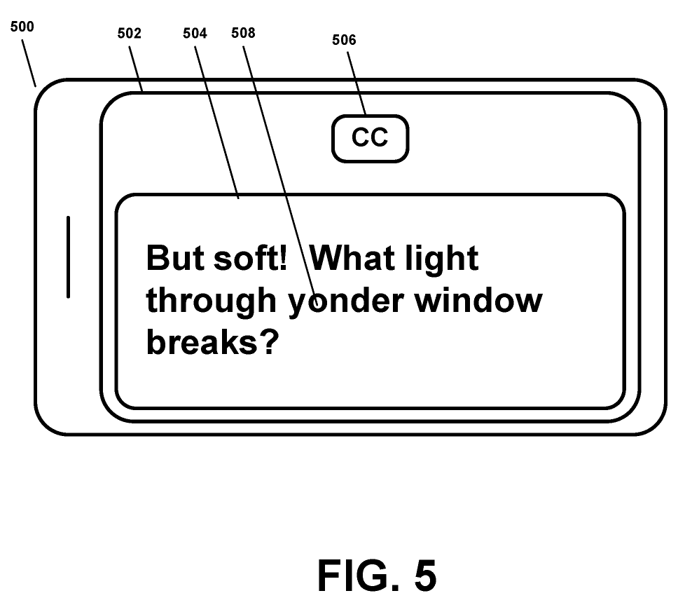

Referring to FIG. 5, a mobile device 500 may provide a client device interface for accessing synchronized captions during live performances through the Caption Processing System 300. In some cases, the mobile device 500 may include a device screen 502 that serves as the primary visual interface for caption display and user interaction. Although not shown, a title bar may be positioned at the top portion of the device screen 502 to provide navigation and status information for the captioning application.

The mobile device 500 may include a text box 504. In some cases, the text box 504 may contain a caption text display 508 that presents synchronized caption content to the user. The caption text display 508 may include a character name (not shown) that identifies the speaking performer and dialogue text that corresponds to the spoken content during the live performance. The character name and dialogue text may be updated in real-time as the Caption Synchronizer 314 sends instructions to display different captions based on word matching results from the Word Matching Engine 312.

A closed captioning indicator 506 may be positioned within the interface to show active caption status and confirm that the captioning service is operational during the performance. In some cases, the closed captioning indicator 506 may provide visual confirmation that the mobile device 500 is receiving synchronized caption data from the Caption Processing System 300. The caption content 508 may be presented within a text display region that organizes the visual presentation of caption information on the device screen 502. A chat icon may be included within the interface to provide additional communication or interaction capabilities for users during the performance.

With continued reference to FIG. 5, a display interface may encompass the overall visual presentation framework for caption content on the mobile device 500. The display interface may coordinate the presentation of caption elements including the caption text display 508. In some cases, a control interface may provide user interaction capabilities through various interface elements positioned on the device screen 502. The control interface may contain control buttons that enable users to adjust caption settings or interact with the captioning application during the performance.

The mobile device 500 may include volume controls and volume adjustment controls that allow users to modify audio settings for their personal devices without affecting the caption display functionality. In some cases, a user interface may provide comprehensive interaction capabilities that enable patrons to access caption settings, adjust display preferences, and manage their connection to the Caption Processing System 300. A text display area may define the specific region where caption content is presented, while a mobile interface may encompass the complete user interaction framework for the captioning application on the mobile device 500.

The client application module 318 within the mobile device 500 may be configured to scan a QR code or receive a link for the scripted live event to establish connection with the Caption Processing System 300. In some cases, the client application module 318 may receive the plurality of captions from the Captions Repository 113 and may receive instructions to display specific captions from the Caption Synchronizer 314. The client application module 318 may display the captions on the display screen 502 in response to the received instructions, enabling synchronized caption presentation throughout the live performance.

Patrons may interact with the mobile interface to access and view synchronized captions throughout the performance by utilizing the control interface and the user interface. The text display area may present caption content that updates automatically based on instructions received from the Caption Synchronizer 314. In some cases, the display interface may coordinate the visual presentation of caption elements to provide a seamless viewing experience for audience members during live performances.

The unique identifier for accessing the Caption Processing System 300 may be generated as one of a quick response (QR) code or a uniform resource locator (URL) to enable patron subscription to the live event captions. In some cases, patrons may scan the QR code using the mobile device 500 camera functionality to automatically connect to the captioning service for the specific performance. The URL implementation may allow patrons to manually enter web addresses into browsers or applications to establish connection with the Caption Processing System 300. The QR code or URL approach may provide flexible access methods that accommodate different user preferences and device capabilities.

The mobile device 500 implementation may represent a technological improvement over conventional captioning systems by providing personalized caption access on patron-owned devices rather than requiring specialized captioning equipment or dedicated display screens. In some cases, the approach may eliminate the need for venues to invest in specialized captioning infrastructure, reducing venue costs for captioning equipment and maintenance. The system may enable patrons to use their preferred devices with familiar interfaces, improving accessibility and user experience compared to conventional captioning approaches that require specialized hardware or designated seating areas. The mobile device 500 approach may provide scalable caption delivery that accommodates varying audience sizes and venue configurations while maintaining synchronization accuracy across multiple personal devices simultaneously during live performances.

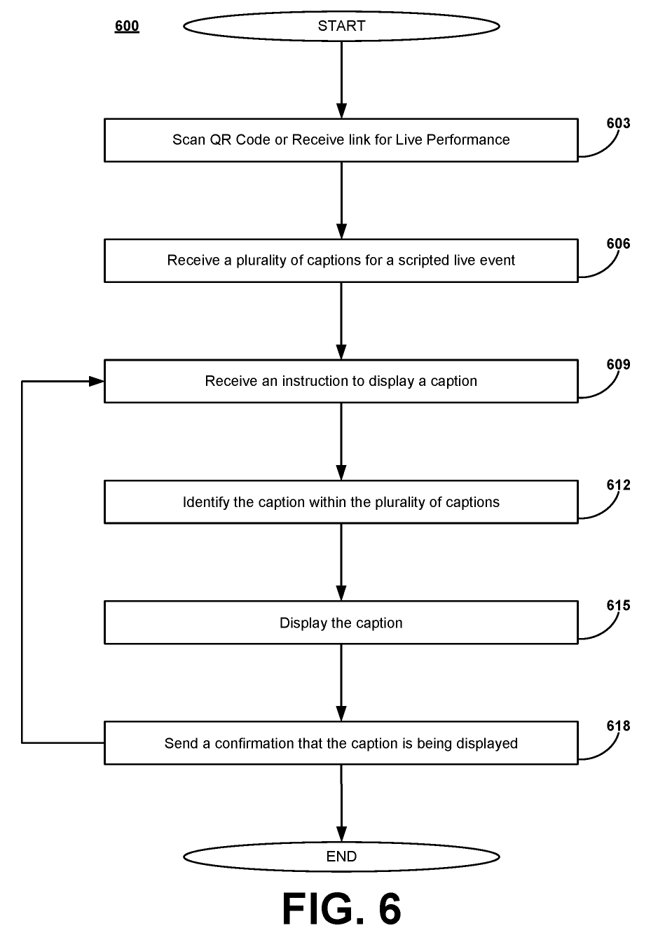

Referring next to FIG. 6, shown is a flowchart depicting method 600 that provides one example of the operator of a portion of the client application 148 according to various embodiments of the present disclosure. The flowchart of FIG. 6 provides merely an example of the many different types of functional arrangements that can be employed to implement the operation of the depicted portion of the client application 148. As an alternative, the flowchart of FIG. 6 can be viewed as depicting an example of elements of a method implemented within the network environment 100.

Beginning with block 603, the client application 148 can scan a QR code or receive a link for a scripted live event. In various embodiments, the client application 148 can utilize an optical device to scan a QR code. In some embodiments, the computing environment 103 can send the client device 112 a link that is unique to the live performance. The client application 148 can follow the link that is unique to the live performance or link embedded within the QR code to request information from the computing environment 103. In at least some embodiments, the client application 148 can receive a confirmation the client device 112 will receive and display the plurality of captions during the progression of the scripted live event. Next, at block 606, the client application 148 can receive a plurality of captions for a scripted live event. In at least some embodiments, the plurality of captions can be the entire captions file 151.

Continuing to block 609, the client application 148 can receive an instruction to display a first caption. In at least some embodiments, the client application 148 can directly receive text as a caption to display on the client display 145. In at least some embodiments, the client application 148 can receive an indication of which caption from the plurality of captions received at block 606 to display. Next, at block 612, the client application 148 can identify the caption from the plurality of captions. Continuing to block 615, the client application 148 can display the caption on the client display 145. In at least some embodiments, the client display 145 can display more than one caption simultaneously. For example, the client display 145 could display three captions simultaneously so that the reader can read at their own pace. In another example, the client display 145 can display a captions in a fixed sized queue. For instance, a first caption can be added to the client display 145 so that the patron can view what is currently being said. A second caption can be added to the client display 145, which pushes the first caption aside; however, both the first caption and the second caption are still readable on the client display 145. A third caption can be added the client display 145, which pushes both of the first caption and the second caption aside; however, each of the first caption, the second caption, and the third caption are still readable on the client display 145. A fourth caption can be added to the client display 145, which makes the first caption disappear from the client display 145, and the second caption and third caption are pushed aside. Each of the second, third, and fourth captions are still readable on the client display 145, however the first caption is not.

Subsequently, at block 618, the client application 148 can send a confirmation that the caption is being displayed to the computing environment 103. Following block 618, the process can return the block 609 if there are any remaining captions for the scripted live event. Otherwise, the process can end.

The method 600 described in FIG. 6 represents a technical improvement over conventional captioning distribution systems by addressing computational challenges associated with client-server synchronization and caption delivery in live performance environments. Traditional captioning systems often rely on centralized display screens or specialized hardware that requires dedicated infrastructure and limits patron accessibility based on seating location or device compatibility. The automated client application methodology implemented through blocks 603, 606, 609, 612, 615, and 618 eliminates these technical limitations by enabling distributed caption delivery to patron-owned devices through standardized communication protocols. The system may reduce infrastructure overhead by utilizing existing mobile device capabilities rather than requiring specialized captioning equipment, enabling scalable deployment across venues of varying sizes and technical capabilities. In some aspects, the client-side caption management approach may provide improved accessibility by allowing patrons to use familiar personal devices with customizable display settings, while the confirmation mechanism in block 618 may enable real-time synchronization monitoring across multiple client devices simultaneously during live performances.

A number of implementations have been described. Nevertheless, it will be understood that various modifications may be made without departing from the spirit and scope of the disclosure. Accordingly, other implementations are within the scope of the following claims.

What is claimed is:

1. A method, comprising:
obtaining a captioning file comprising a first caption and a second caption;
obtaining a live transcript from a transcription service, the live transcript representing text generated from audio input;
sending a first instruction to a client device to render the first caption;
calculating, in response to identifying a change in the live transcript, a first match percentage, the first match percentage representing a first amount that the first caption matches a first portion of the live transcript over a first word count of the first caption; and
sending a second instruction to the client device to render the second caption.

2. The method of claim 1, wherein the second instruction is sent to the client device in response to determining that the first match percentage exceeds a predetermined threshold.

3. The method of claim 1, further comprising calculating, in response to determining that the first match percentage fails to exceed a first predetermined threshold, a second match percentage, the second match percentage representing a second amount that at least a second portion of the second caption matches the first portion of the live transcript over a second word count of the second portion of the second caption.

4. The method of claim 3, wherein the second instruction is sent to the client device in response to determining that the second match percentage exceeds a second predetermined threshold.

5. The method of claim 3, wherein the captioning file further comprises a third caption and the method further comprises calculating, in response to determining that the first match percentage fails to exceed the first predetermined threshold and the second match percentage fails to exceed a second predetermined threshold, a third match percentage, the third match percentage representing a third amount that at least a third portion of the third caption matches the first portion of the live transcript over a third word count of the third portion of the third caption.

6. The method of claim 5, wherein the second instruction is sent to the client device in response to determining that the third match percentage exceeds a third predetermined threshold.

7. The method of claim 1, wherein the second instruction is sent to the client device in response to determining that a second word count of the live transcript exceeds the first word count of the first caption.

8. The method of claim 1, wherein the transcription service is a speech-to-text (S2T) service configured to receive the audio input from an audio input device and convert the audio input into text.

9. A system, comprising:
an audio input device;
a computing device comprising a processor and memory; and
machine-readable instructions stored in the memory that, when executed by the processor, cause the computing device to at least:
receive a plurality of captions for a scripted live event;
receive, from the audio input device, audio input from the scripted live event;
transcribe the audio input into a live transcript;
send a first caption of the plurality of captions to a client device;
determine, in response to a change to the live transcript, that a first percentage of words within the first caption matches a first portion of the live transcript; and
send a second caption of the plurality of captions to the client device.

10. The system of claim 9, wherein the machine-readable instructions that send the second caption of the plurality of captions to the client device is executed by the processor in response to determining that the first percentage of words within the first caption matches the first portion of the live transcript.

11. The system of claim 9, wherein the machine-readable instructions that transcribe the audio input into the live transcript is repeatedly executed by the processor until a final caption of the plurality of captions has been sent to the client device.

12. The system of claim 9, wherein:
the system further comprises an operator display and an operator input device;
the machine-readable instructions, when executed by the processor, further cause the computing device to at least receive operator input from the operator input device, the operator input indicating that a client display should be advanced from the first caption to the second caption; and
the machine-readable instructions that send the second caption of the plurality of captions to the client device is executed by the processor in response to receiving the operator input from the operator input device.

13. The system of claim 9, wherein the machine-readable instructions, when executed by the processor, further cause the computing device to at least generate a QR code for the scripted live event, such that when the QR code is interpreted by the client device, the client device is added to a list of client devices to receive the plurality of captions during the scripted live event.

14. The system of claim 9, wherein the machine-readable instructions, when executed by the processor, further cause the computing device to at least:
generate a unique link for the scripted live event; and
send the unique link for the scripted live event to the client device.

15. A method, comprising:
receiving, by a client device, a plurality of captions for a scripted live event;
receiving, by the client device from an operator device, a first instruction to display a first caption of the plurality of captions;
identifying, by the client device, the first caption within the plurality of captions;
displaying, by the client device, the first caption;
receiving, by the client device and from the operator device, a second instruction to display a second caption of the plurality of captions;
identifying, by the client device, the second caption within the plurality of captions;
displaying, by the client device, the second caption.

16. The method of claim 15, further comprising:
scanning, by the client device, a QR code for the scripted live event;
receiving, by the client device, a confirmation that the client device will receive and display the plurality of captions during a progression of the scripted live event.

17. The method of claim 15, further comprising sending, by the client device and to the operator device, a confirmation that the client device is displaying the first caption of the plurality of captions.

18. The method of claim 15, further comprising sending, by the client device and to the operator device, a confirmation that the client device is displaying the second caption of the plurality of captions.

19. The method of claim 15, further comprising removing, by the client device, the first caption from display.

20. The method of claim 15, wherein the plurality of captions are displayed within an internet browser on the client device.
